(19) United States
(12) Patent Application Publication
(10) Pub. No.: US 2024/0134606 A1
(43) Pub. Date: Apr. 25, 2024

(54) DEVICE AND METHOD WITH IN-MEMORY COMPUTING

(71) Applicant: SAMSUNG ELECTRONICS CO., LTD., Suwon-si (KR)

(72) Inventors: Wooseok YI, Suwon-si (KR); Soon-Wan KWON, Suwon-si (KR); Seungchul JUNG, Suwon-si (KR)

(73) Assignee: SAMSUNG ELECTRONICS CO., LTD., Suwon-si (KR)

(21) Appl. No.: 18/322,837

(22) Filed: May 23, 2023

(30) Foreign Application Priority Data
Oct. 24, 2022 (KR) 10-2022-0138360

(51) Int. Cl. G06F 7/544; G06F 7/556

(52) U.S. Cl. CPC G06F 7/5443; G06F 7/556

(57) ABSTRACT

A memory device includes: a computing module; and an in-memory computing (IMC) macro comprising: a memory comprising a plurality of bit cells storing pieces of fraction data of a first data set; and an IMC computing module configured to perform an operation between the pieces of fraction data of the first data set read from the memory and pieces of fraction data of a second data set received from an input control module, wherein a plurality of pieces of data included in the first data set share a first exponent, and wherein a plurality of pieces of data included in the second data set share a second exponent.

### CROSS-REFERENCE TO RELATED APPLICATIONS

This application claims the benefit under 35 USC § 119(a) of Korean Patent Application No. 10-2022-0138360, filed on Oct. 25, 2022 in the Korean Intellectual Property Office, the entire disclosure of which is incorporated herein by reference for all purposes.

### BACKGROUND

### 1. Field

The following description relates to a device and method with in-memory computing.

### 2. Description of Related Art

When artificial neural network models are used for learning and inference, the IEEE FP32 format has been used, however, the use of a network quantized to fixed/float 16-bit or less or the use of a separate format such as brain-floating point (bfloat) 16-bit is gradually increasing. Accordingly, instead of a central processing unit (CPU)/graphics processing unit (GPU) that does not efficiently support operations in these new formats, an application-specific integrated circuit (ASIC) specialized for the corresponding operations may be used. A separate format may be used due to characteristics of a neural network, in that a network trained with a lower quantization bit may have an accuracy which is not significantly different compared to a network trained by the FP32 format or a similar level of accuracy may be obtained through additional training.

However, such hardware platforms may be incapable of efficiently performing operations of a large-scale network model.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a memory device includes: a computing module; and an in-memory computing (IMC) macro comprising: a memory comprising a plurality of bit cells storing pieces of fraction data of a first data set; and an IMC computing module configured to perform an operation between the pieces of fraction data of the first data set read from the memory and pieces of fraction data of a second data set received from an input control module, wherein a plurality of pieces of data included in the first data set share a first exponent, and wherein a plurality of pieces of data included in the second data set share a second exponent.

The pieces of the fraction data of the first data set may be converted into the format of two's complement and stored in the plurality of bit cells, and the pieces of the fraction data of the second data set may be converted into the format of two's complement and streamed in the IMC macro.

The IMC computing module may include: a multiplier configured to perform a multiplication operation between the pieces of the fraction data of the first data set and the pieces of the fraction data of the second data set; and an adder tree configured to add results of performing the multiplication operation, and the adder tree may be configured with a full adder.

The IMC computing module may be configured to stream the pieces of the fraction data of the second data set in a bit-serial manner.

The IMC macro may include a plurality of IMC macro blocks, and the computing module further may include a shift accumulator configured to accumulate adder tree operation results of each of the plurality of IMC macro blocks.

The computing module further may include a multiplexer module configured to be connected to one or more IMC macro blocks among the plurality of IMC macro blocks and transmit an output signal corresponding to each of a plurality of operation modes to the shift accumulator, and the shift accumulator may be configured to be connected to the multiplexer module and accumulate the adder tree operation results based on the output signal corresponding to each of the plurality of operation modes.

The plurality of operation modes may be determined based on the plurality of IMC macro blocks.

The computing module further may include an exponent adder configured to perform an addition operation between exponent data of the first data set and exponent data of the second data set.

The computing module further may include a normalization module configured to receive an output of a shift accumulator and an output of an exponent adder and output a result of an operation between the first data set and the second data set.

The computing module further may include a bit-serial counter configured to control operations of a multiplexer module, shift accumulator, exponent adder, and normalization module based on the fraction data of the second data set.

The IMC macro may include a first IMC macro block and a second IMC macro block, and the computing module further may include a multiplexer module configured to: perform a concatenate operation on an adder tree operation result of the first IMC macro block and an adder tree operation result of the second IMC macro block in response to a first operation mode; and perform an addition operation between a value obtained by shifting the adder tree operation result of the first IMC macro block by a first bit and the adder tree operation result of the second IMC macro block in response to a second operation mode.

The computing module further may include a shift accumulator configured to: accumulate results of performing the concatenate operation by dividing the results into two in response to the first operation mode; and accumulate results of performing the addition operation in response to the second operation mode.

A bit-width of the shift accumulator may be determined based on the number of the pieces of the fraction data of the first data set, a bit number of the pieces of the fraction data of the first data set, and a bit number of the pieces of the fraction data of the second data set.

In another general aspect, a processor-implemented method of operating a memory device includes: reading pieces of fraction data of first data set stored in an in-memory computing (IMC) macro; streaming fraction data of second data set in a bit-serial manner; and performing a multiply and accumulate (MAC) operation between the fraction data of the first data set and the fraction data of the set 2 data, wherein a plurality of pieces of data included in the first data set shares a first exponent, and wherein a plurality of pieces of data included in the second data set shares a second exponent.

The pieces of the fraction data of the first data set may be converted into the format of two's complement and stored in the IMC macro, and the pieces of the fraction data of the second data set may be converted into the format of two's complement and streamed in the IMC macro.

The IMC macro may include a plurality of IMC macro blocks, and the method further may include: transmitting an output signal corresponding to each of a plurality of operation modes to a shift accumulator by using a multiplexer module connected to one or more IMC macro blocks among the plurality of IMC macro blocks; and accumulating adder tree operation results of each of the plurality of IMC macro blocks based on the output signal corresponding to each of the plurality of operation modes by using the shift accumulator.

The plurality of operation modes may be determined based on the plurality of IMC macro blocks.

The method further may include: performing an addition operation between exponent data of the first data set and exponent data of the second data set; and outputting a result of an operation between the first data set and the second data set based on a result of the MAC operation and a result of performing the addition operation.

In another general aspect, one or more embodiments include a non-transitory computer-readable storage medium storing instructions that, when executed by one or more processors, configure the one or more processors to perform any one of, any combination of, or all operations and methods described herein.

In another general aspect, a memory device includes: an in-memory computing (IMC) macro comprising: a memory comprising a plurality of bit cells storing pieces of fraction data of a first data set; and an IMC computing module configured to perform an operation between the pieces of fraction data of the first data set read from the memory and pieces of fraction data of a second data set received from an input control module, wherein a plurality of pieces of data included in the first data set share a first exponent, and wherein a plurality of pieces of data included in the second data set share a second exponent.

Other features and aspects will be apparent from the following detailed description, the drawings, and the claims.

### BRIEF DESCRIPTION OF THE DRAWINGS

FIG. 1 illustrates an example of an in-memory computing (IMC) system for a multiply and accumulate (MAC) operation of a neural network.

FIG. 2 illustrates an example of a configuration of a memory device in an IMC system.

FIG. 3 illustrates an example of a block floating point.

FIG. 4 illustrates an example of a data input method of a memory device.

FIG. 5 illustrates an example of a method of providing a plurality of bit-precisions.

FIG. 6 illustrates an example of a two's complement block floating point format.

FIG. 7 illustrates an example of a hardware structure of a memory device.

FIG. 8 illustrates a hardware structure of a memory device including a plurality of IMC columns.

FIGS. 9 to 11 illustrate examples of a method of operating a shift accumulator module and a multiplexer module.

FIG. 12 illustrates an example of a method of operating an IMC macro.

FIG. 13 illustrates an example of an operation of a bit-serial counter module.

FIG. 14 illustrates an example of an operation of a multiplexer module.

FIG. 15 illustrates an example of an operation of a shift accumulator module.

FIG. 16 illustrates an example of an operation of an exponent adder module.

FIG. 17 illustrates an example of an operation of a normalization module.

FIG. 18 illustrates an example of performing an operation by using a plurality of IMC macro blocks.

FIG. 19 illustrates an example of performing an operation by using a plurality of IMC columns.

FIG. 20 illustrates an example of a method of operating a memory device.

FIG. 21 illustrates an example of replacing an IMC macro with a static random-access memory (SRAM)-based IMC IP according to an example.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as being “on”, “connected to,” “coupled to,” or “joined to” another component, element, or layer it may be directly (e.g., in contact with the other component or element) “on”, “connected to,” “coupled to,” or “joined to” the other component, element, or layer or there may reasonably be one or more other components, elements, layers intervening therebetween. When a component or element is described as being “directly on”, “directly connected to,” “directly coupled to,” or “directly joined” to another component or element, there can be no other elements intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Unless otherwise defined, all terms used herein including technical or scientific terms have the same meanings as those generally understood, consistent with and after an understanding of the present disclosure. Terms, such as those defined in commonly used dictionaries, should be construed to have meanings matching with contextual meanings in the relevant art and the present disclosure, and are not to be construed as an ideal or excessively formal meaning unless otherwise defined herein. The use of the term “may” herein with respect to an example or embodiment, e.g., as to what an example or embodiment may include or implement, means that at least one example or embodiment exists where such a feature is included or implemented, while all examples are not limited thereto.

As used herein, the term “and/or” includes any one and any combination of any two or more of the associated listed items. The phrases “at least one of A, B, and C”, “at least one of A, B, or C’, and the like are intended to have disjunctive meanings, and these phrases “at least one of A, B, and C”, “at least one of A, B, or C’, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The examples may be implemented as various types of products, such as, for example, a personal computer (PC), a laptop computer, a tablet computer, a smartphone, a television (TV), a smart home appliance, an intelligent vehicle, a kiosk, and/or a wearable device. Hereinafter, examples will be described in detail with reference to the accompanying drawings. When describing the examples with reference to the accompanying drawings, like reference numerals refer to like components and a repeated description related thereto will be omitted.

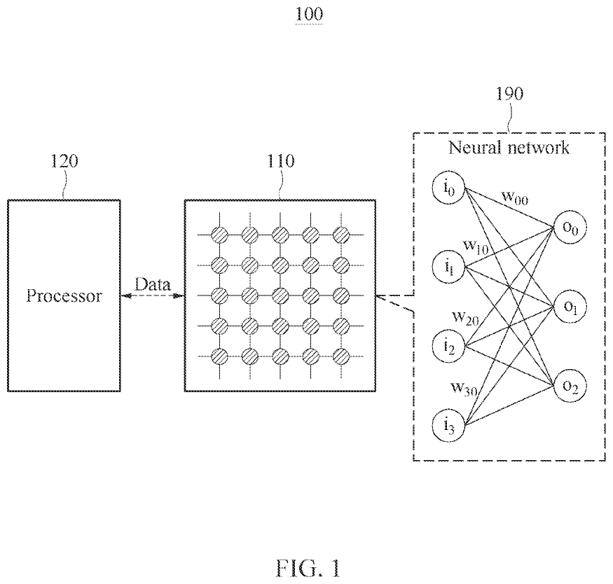

FIG. 1 illustrates an example of an in-memory computing (IMC) system for a multiply and accumulate (MAC) operation of a neural network.

In Von Neumann architecture, performance and power limitations may occur due to frequent data movement between an IMC computing module and memory. IMC architectures may allow operations to be performed directly in a memory storing data (e.g., a memory device 110), and may thus reduce data movement between a processor 120 (e.g., including one or more processors) and the memory device 110 (e.g., one or more memory devices) and also increase power efficiency. The processor 120 of an IMC system 100 according to one or more embodiments may input data to be operated to the memory device 110, and the memory device 110 may perform an operation by itself on the inputted data. The processor 120 may read a result of the operation from the memory device 110. Therefore, the IMC system 100 according to one or more embodiments may minimize the data transmission during an operation process.

For example, the IMC system 100 may perform a MAC operation used in an artificial intelligence (AI) process among various operations. As shown in FIG. 1, a layer operation 190 in a neural network may include a MAC operation of adding results obtained by multiplying weights by each of input values of input nodes. An example of a MAC operation may be expressed as in Expression 1 below, for example.

$${O}_{0} = {\sum }_{m = 0}^{M - 1} {I}_{m} {W}_{0 , m} , {O}_{1} = {\sum }_{m = 0}^{M - 1} {I}_{m} {W}_{1 , m} , … , \\ {O}_{T - 1} = {\sum }_{m = 0}^{M - 1} {I}_{m} {W}_{T - 1 , m} \qquad Expression 1$$

In Expression 1, for a current network layer, there are M inputs provided to each of T nodes of the current layer. In Expression 1, Oₜ represents an output of a t-th of the T nodes, Iₘ represents an m-th of the M inputs, and W_{t,m} represents a weight applied to an m-th input which is input to the t-th node. Here, Oₜ is an output of a node or a node value and may be calculated as a weighted sum of inputs Iₘ and weights W_{t,m}. Here, m is an integer of 0 or more and M−1 or less, t is an integer of 0 or more and T−1 or less, and M and T are integers. M is the number of nodes of a previous layer connected to one node of the current layer to be operated, and T is the number of nodes of the current layer.

The memory device 110 of the IMC system 100 according to an example may perform the MAC operation described above. The memory device 110 may also be referred to as a resistive memory device, a memory array, and/or an IMC device. However, the memory device 110 is not limited to being used for the MAC operation, and the memory device 110 may be used to store the memory and perform other operations, for example a multiplication operation. Non-limiting examples of computing structures for the memory device 110 to perform operations directly in the memory without necessarily moving data are described below.

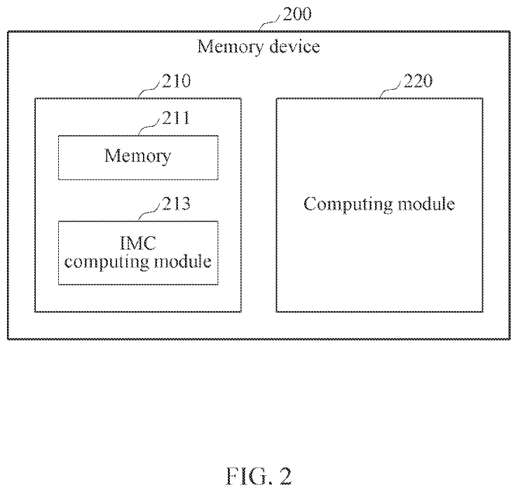

FIG. 2 illustrates an example of a configuration of a memory device in an IMC system.

Referring to FIG. 2, a memory device 200 (e.g., the memory device 110 of FIG. 1) may include an IMC macro 210 and a computing module 220.

The term “module” used below may refer to, for example, a unit including hardware, e.g., hardware implementing executable instructions. The “module” may be interchangeably used with other terms, for example, unit, logic, logical block, component, or circuit. The “module” may be a minimum unit or part of a single integral component. The “module” may be a minimum unit or part to perform one or more functions. The “module” may be implemented mechanically or electronically. For example, the “module” may include at least one of an application-specific integrated circuit (ASIC) chip, a field-programmable gate arrays (FPGAs), and/or a programmable-logic device for performing certain operations that are well known or to be developed in the future.

The IMC macro 210 may include a memory 211 (e.g., one or more memories) and an IMC computing module 213 (e.g., one or more computing modules). The IMC computing module 213 may be a computing unit. The suffixes such as “-er,” “-or,” etc. of such components, as used hereinafter, may refer to a part for processing at least one function or operation and may be implemented as hardware, e.g., hardware implementing executable instructions.

In a digital IMC system and/or circuit, operations may be performed with most or all pieces of data stored therein, which are expressed as logic values, and thus an input value, weight, and output value may all have a binary format. The components described with reference to FIG. 2 may be implemented based on a digital logic circuit.

The memory 211 may be composed of a plurality of bit-cells, each of which may store respective bit data (e.g., a bit weight). The bit cells may also be referred to as ‘memory cells’. The bit cells may include, for example, at least one of a diode, transistor (e.g., a metal-oxide-semiconductor field-effect transistor (MOSFET)), static random access memory (SRAM) bit cells, and/or resistive memory. However, examples are not necessarily limited thereto.

The memory device 200 according to an example may perform the MAC operation through the IMC computing module 213. The IMC computing module 213 may include a multiplier, an adder tree, and an accumulator.

Although will be described in detail below, the memory device 200 may be used in an application that performs a vector-vector inner product operation or vector-matrix operation. For example, the memory device according to an example may be used for a hardware accelerator that performs operations of a neural network such as a convolutional neural network (CNN), recurrent neural network (RNN), long short-term memory (LSTM), transformer, Bidirectional Encoder Representations (BERT), and/or GPT-3.

When the memory device 200 uses a block floating point, a decrease of accuracy in a viewpoint of a data format, memory usage, and data movement between the memory and the hardware accelerator may be minimized, and thus the memory device 200 may perform operations with high power efficiency.

The memory device 200 may obtain additional power efficiency by performing operations using an IMC block, compared to a typical digital operation configuration. Through this, the memory device 200 may achieve high power efficiency when the memory device 200 is used for large-scale operations such as operations in a data center, as well as operations in mobile and desktop environments.

The memory device 200 may perform mantissa addition operation by using only one full adder, regardless of a sign bit, by performing an operation using a fraction converted into the format of a two's complement.

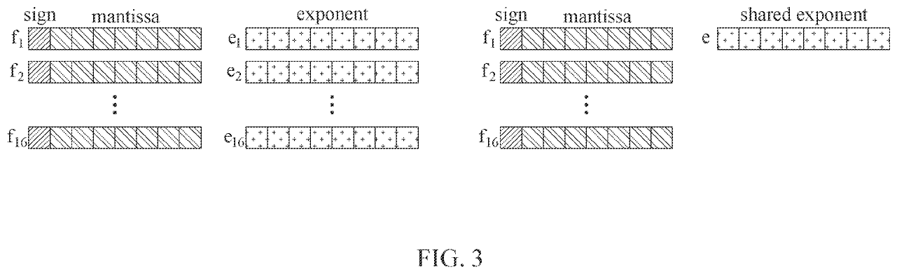

FIG. 3 illustrates an example of a block floating point.

When performing an inner product operation of pieces of general floating point data, and when performing an addition operation after the multiplication of the floating point data, the addition operation may be performed by matching a value of an exponent of each floating point data each time. When exponent values of two multiplied results are compared and then the addition operation is performed while shifting a fraction value accordingly, as in a typical memory device, a considerable amount of operation resources may be used compared to performing the addition after a simple integer multiplication operation.

When the block floating point format according to an example is used, a memory device of one or more embodiments may perform an operation of adding a multiplied result of two integers multiple times, instead of adding a multiplied result of two pieces of floating point data multiple times as in the typical memory device, and the memory device of one or more embodiments may obtain one floating point data result by adding exponents of two pieces of block floating point data.

Referring to FIG. 3, the block floating point data according to an example may be a data set in which several pieces of floating point data share one exponent. The fraction of other floating points may be digit-matched by using a maximum value of exponential values of each data in the pieces of the existing floating point data as a reference to obtain one piece of block floating point data.

Further, when the value of the exponent shared in the corresponding block floating point data is 0, the block floating point data used as an input may be interpreted as a block integer by considering the fraction as an integer. Even when the exponent is not 0, the block floating point data may be interpreted as a block integer multiplied by a common exponent by interpreting the fraction as an integer through a separate mode.

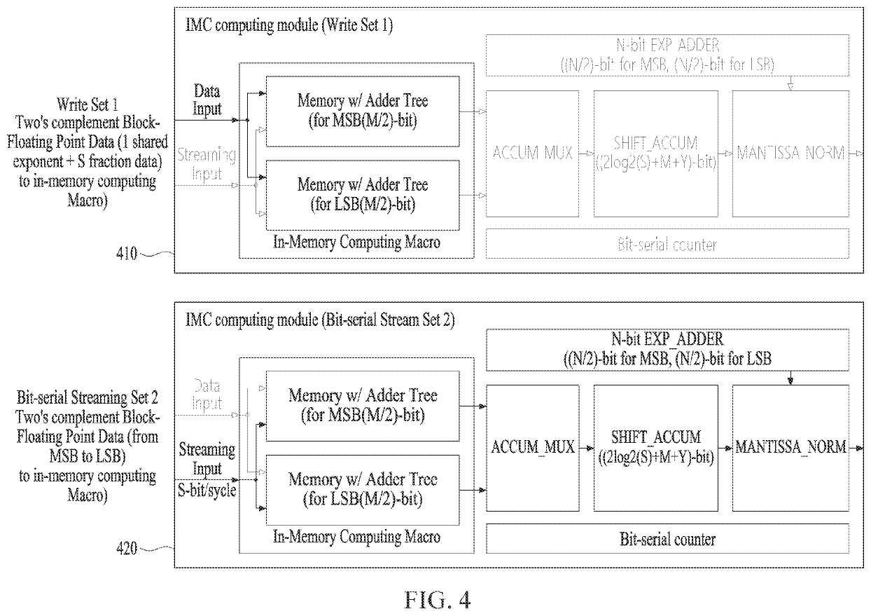

FIG. 4 illustrates an example of a data input method of a memory device.

Referring to FIG. 4, the memory device according to an example may perform a vector inner product operation or vector-matrix multiplication operation between pieces of block floating point data by firstly receiving one piece of block floating point data, storing this in the IMC macro (e.g., the IMC macro 210 of FIG. 2), then receiving another block floating point data in a bit-serial manner, and streaming this in the IMC macro, instead of performing an operation of a typical block floating point computing unit that performs an operation by receiving two pieces of block floating point data at the same time.

Hereinafter, the block floating point data stored in the IMC macro may be referred to as set 1 data (e.g., a first data set), and the block floating point data streamed in the IMC macro subsequently may be referred to as set 2 data (e.g., a second data set).

Referring to a diagram 410, block floating point data corresponding to the set 1 data according to an example may be stored (or written) in a memory (e.g., the memory 211 of FIG. 2) of the IMC macro. For example, the memory device may receive an address value and data of the block floating point data corresponding to the set 1 data and write them in an internal memory.

When the number of pieces of fraction data sharing one exponent (shared exponent) is defined as S and a bit number of each fraction data is defined as M, one piece of the set 1 data may be composed of 1 shared exponent and S M-bit fractions. Further, the IMC macro may store one or more pieces of the set 1 data. When the number of storable pieces of the set 1 data is defined as B, a memory size of the IMC macro may be (S×M×B)-bit.

Referring to a diagram 420, the memory device may stream the set 2 data in the IMC macro in a bit-serial manner in the order from a most significant bit (MSB) to a least significant bit (LSB).

The memory device according to an example may accumulate results of operations between the set 1 data and the set 2 data in a shift accumulator module (e.g., a SHIFT_ACCUM module). A bit-serial counter module according to an example may count the order of bit a current input of the streamed set 2 data corresponds to, and accordingly, determine whether to perform operations of an exponent adder module (e.g., EXP_ADDER) for adding an exponent and a normalization module (e.g., a mantissa normalizer or MANTISSA_NORM) for converting a final accumulated value into the floating point format.

Further, the memory device according to an example may divide M-bit fraction data of the set 1 data into two pieces and perform each operation. The IMC macro according to an example may include a plurality of IMC macro blocks for performing operations, respectively. Each of the IMC macro blocks may include a memory (e.g., of the memory 211 of FIG. 2) and an IMC computing module (e.g., of the computing module 213 of FIG. 2).

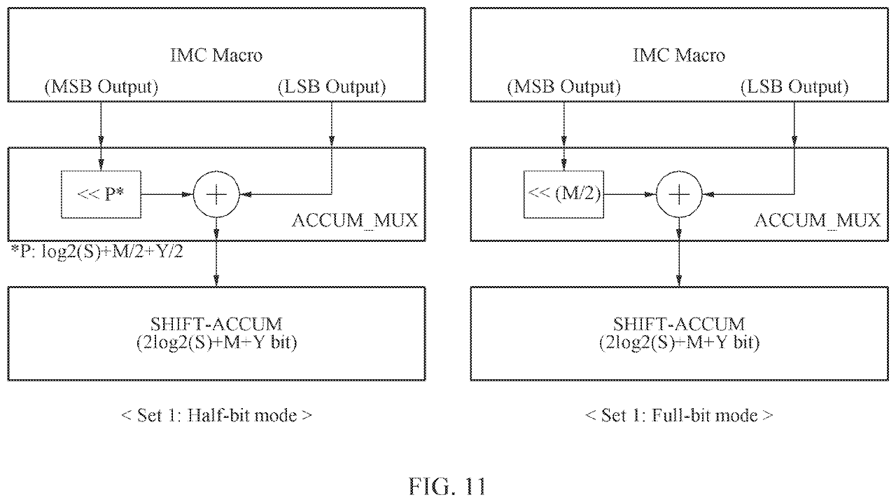

For example, when dividing the fraction data of the set 1 data into two pieces, the M-bit fraction data of the set 1 data may be divided into MSB (M/2)-bit and LSB (M/2) bit and stored in memories of two IMC macro blocks, respectively, and an operation may be performed in each adder tree. Then, operation result values obtained by two adder trees may be appropriately added in a multiplexer module (e.g., ACCUM_MUX) according to an operation mode (e.g., a bit-mode) of the data currently being used, and results of the adding in the multiplexer module may be accumulated in the shift accumulator. A non-limiting example of a method of operating the modules constituting the computing module will be described in detail with reference to FIGS. 13 to 17.

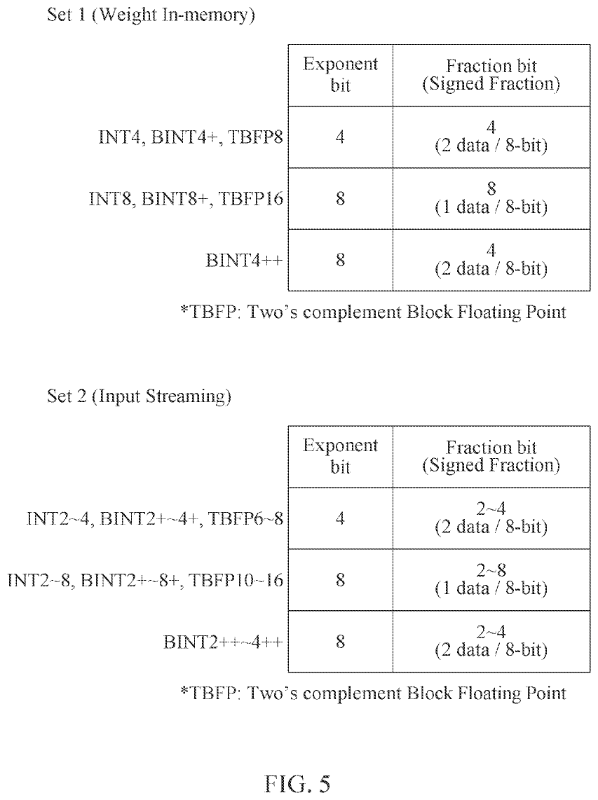

FIG. 5 illustrates an example of a method of providing a plurality of bit-precisions.

Referring to FIG. 5, the memory device according to an example may adjust bit-precisions of two block floating points used in the operation within a predetermined range.

Exponent data of the set 1 data may have a bit-precision of N-bit and (N/2)-bit and the fraction data thereof may have a bit-precision of M-bit and (M/2)-bit. On the other hand, exponent data of the set 2 data that is input in a bit-serial streaming method may have a bit-precision of X-bit and (X/2)-bit and the fraction data may have any one bit-precision of 2-bit to Y-bit.

For example, when S=16 and N=M=X=Y=8, the set 1 data may be composed of 8-bit or 4-bit exponent data and fraction data and the set 2 data may be composed of 8-bit or 4-bit exponent data and fraction data of any one of 2-bit to 8-bit.

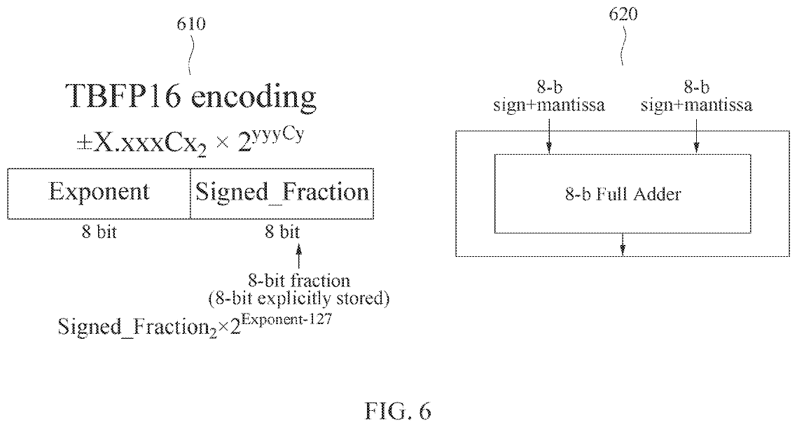

TBFP according to an example may refer to a two's complement block floating point format and BINT may refer to an integer in the form of a block sharing a shared scale factor. The two's complement block floating point format according to an example will be described in detail with reference to FIG. 6.

FIG. 6 illustrates an example of a two's complement block floating point format.

Referring to FIG. 6, the memory device according to an example may use the two's complement floating point format as a number representation format of the fractions of the block floating points of the set 1 data and the set 2 data, instead of using a sign-magnitude format which is the typical IEEE-754 standard format.

The memory device according to an example may use the two's complement floating point format, as a supported format, to support an integer operation as well as the floating point operation.

For example, referring to a diagram 610, the memory device according to an example may use two's complement 16-bit block floating point format (TBFP16), which may be composed of an 8-bit exponent and an 8-bit signed mantissa.

In a case of the addition operation of multiplications of the block floating points, referring to a diagram 620, the addition operation of the fractions may be performed. In a case of the sign-magnitude format, two fractions (e.g., 7-bit fractions) may be operated by the adder or subtractor, respectively, according to sign bit values of the two numbers to be added. Accordingly, in this case, the IMC computing module of the memory device may further include a sign comparator and subtractor as well as an adder.

In contrast, in a case of the two's complement format, the addition operation of two signed fraction (e.g., 8-bit signed fraction) values may be performed by one full adder (e.g., 8-bit full adder).

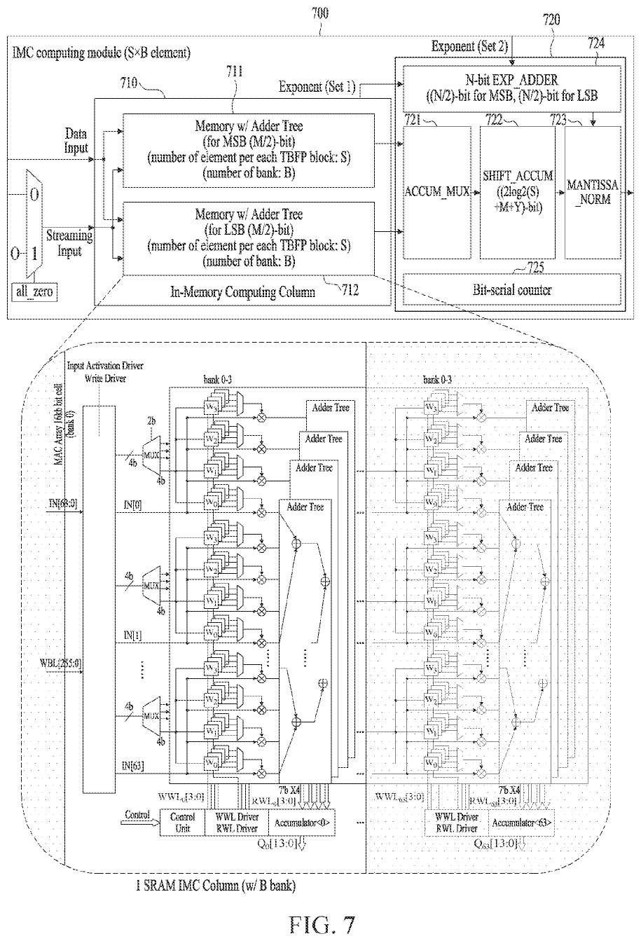

FIG. 7 illustrates an example of a hardware structure of a memory device.

Referring to FIG. 7, a memory device 700 according to an example may include an IMC macro 710 and a computing module 720. However, the memory device 700 is not limited to that shown in FIG. 7. It is to be understood by one of ordinary skill in the art to which the disclosure pertains that some of the components shown in FIG. 7 may be omitted or new components may be added according to the design of the memory device 700. Furthermore, the memory device 700 may also be referred to as an operation device or an IMC computing module.

The description provided with reference to FIGS. 1 to 6 may be identically applicable to the example of FIG. 7, and thus, a duplicate description will be omitted. For example, the IMC macro 710 and the computing module 720 may be the IMC macro 210 and computing module 220 described with reference to FIG. 2, respectively.

The IMC macro 710 may include a first IMC macro block 711 and a second IMC macro block 712.

The computing module 720 may include a multiplexer module 721, a shift accumulator module 722, a normalization module 723, an exponent adder module 724, and a bit-serial counter module 725.

Each of the first IMC macro block 711 and the second IMC macro block 712 of the IMC macro 710 of the memory device 700 may store B sets of TBFP in which S pieces of floating point data share one piece of exponent data.

Each of the first IMC macro block 711 and the second IMC macro block 712 may include B banks (e.g., 4 banks), and each of the banks may include a plurality of memory cells. The banks may share the same adder tree, and thus may store B pieces of different block floating point data, such that different block floating point data operations may be performed according to time.

The memory device 700 may receive one piece of set 2 data at a time, and output one piece of floating point data as an operation result thereof. In such a case of only outputting one piece of data at a time, the IMC macro may be referred to as an IMC column and the IMC column in this case may store (S×1) elements.

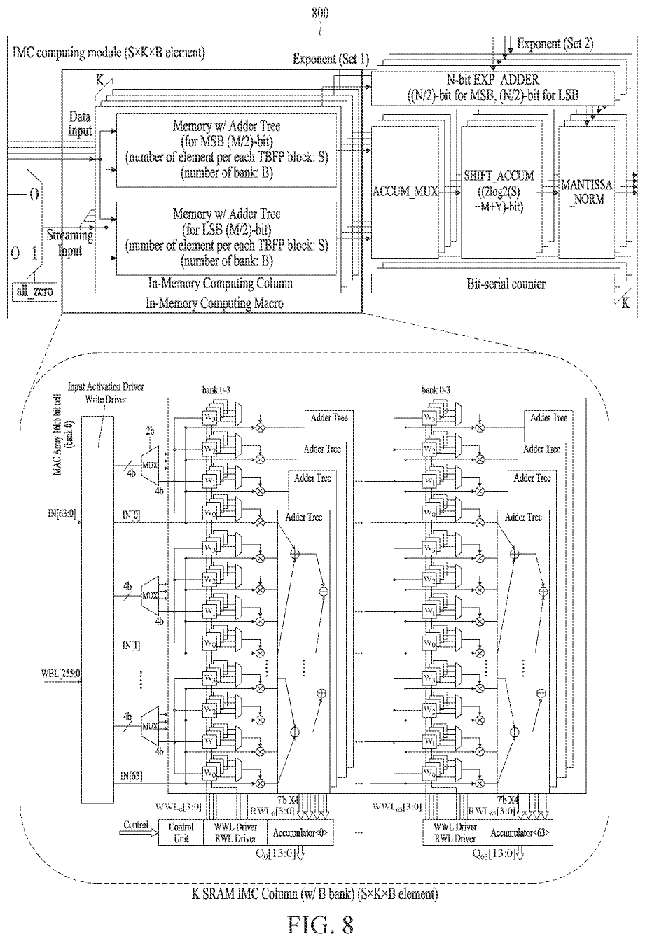

FIG. 8 illustrates a hardware structure of a memory device including a plurality of IMC columns.

Referring to FIG. 8, an IMC macro of a memory device 800 according to an example may include a plurality of IMC columns (e.g., K columns).

The IMC macro of the memory device 800 may store (B×K) sets of TBFP in which S floating points share one piece of exponent data.

The memory device 800 may perform a parallel operation on K different pieces of the set 1 data for an input of one piece of the set 2 data. Accordingly, the memory device 800 may receive an input of one piece of the set 2 data at a time and may output K outputs as a result of the operation thereof.

The memory device 800 may store a weight with an element size of (S×K) as the set 1 data, receive an input (e.g., an input activation) with an element size of (1×S) as the set 2 data, and perform a vector-matrix multiplication operation of outputting output data with an element size of (K×1). At that time, the memory device 800 may store B weights in an internal memory cell.

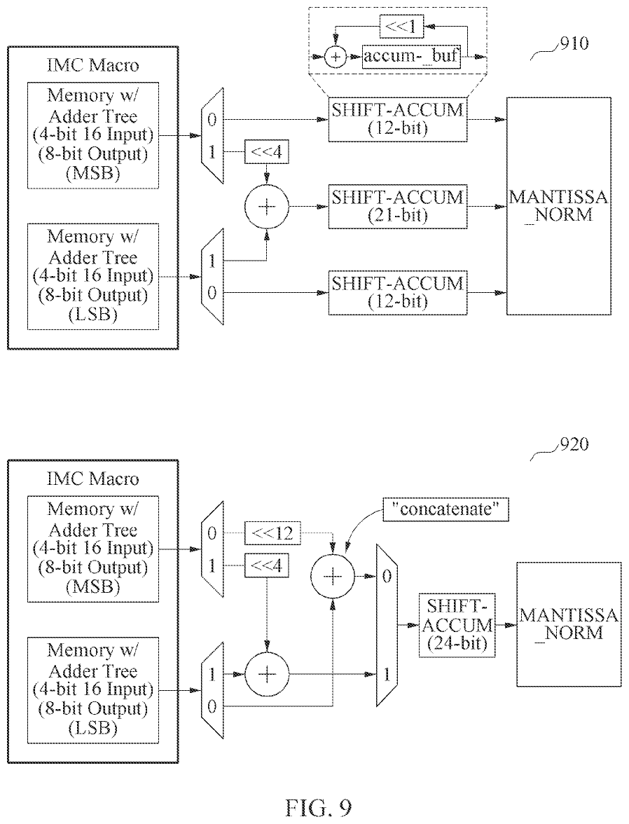

FIGS. 9 to 11 illustrate examples of a method of operating a shift accumulator module and a multiplexer module.

In performing a vector inner product operation or vector-matrix multiplication operation between block floating-point data of the set 1 data and set 2 data, the memory device according to an example may perform an operation between different bit-precisions in one buffer when a shifting accumulation buffer for accumulating values finally to output one floating point result by accumulating values is implemented.

Hereinafter, it is assumed that S=16 and N=M=X=Y=8 for convenience of description, but the example is not limited thereto. The memory device according to the example may divide 16 pieces of 8-bit fraction data of the set 1 data into MSB and LSB by 4-bit and perform the addition through the adder tree, differently add these in the ACCUM_MUX module according to a bit mode (e.g., half-bit mode: 0 or full-bit mode: 1) of the set 1 data to input the result to the SHIFT_ACCUM module.

Referring to FIG. 9, the memory device according to an example may obtain two cases of the SHIFT ACCUM module.

Referring to a diagram 910, a first case is a case where result values of two adder trees in cases where the bit mode of the set 1 data is a first mode (e.g., the half-bit mode (a control signal of “0”)) and a second mode (e.g., the full-bit mode (a control signal of “1”)) are added by using different SHIFT_ACCUM modules. In the first mode (e.g., the half-bit mode), the output of the adder tree is 8-bit that is to be shifted and accumulated by a 4-bit input of the set 2 data, and thus a 12-bit accumulation buffer may be used for each of the MSB and LSB data. On the other hand, in the second mode (e.g., the full-bit mode), a value obtained by adding the outputs of the 4-bit shifted MSB adder tree and LSB adder tree is to be added to the SHIFT_ACCUM module and the 13-bit output is to be accumulated in the SHIFT_ACCUM module by an 8-bit input of the set 2 data. Accordingly, a 21-bit accumulation buffer in total may be used. Hereinafter, the bit-width of the shift accumulator may be understood as a bit-width of the accumulation buffer included in the shift accumulator.

Referring to a diagram 920, a second case is a case where result values of the two adder trees are accumulated in one SHIFT_ACCUM module according to the bit mode of the set 1 data. At this time, an accumulation buffer of the SHIFT_ACCUM module may have a size of 24-bit, which is twice the bit-width used in the first mode (e.g., the half-bit mode). In the first mode (e.g., the half-bit mode), the output value obtained from the MSB adder tree is shifted by 12-bit and added to the LSB input, which eventually corresponds to that an output value of the MSB adder tree and an output value of the LSB adder tree are set to have 12-bit, respectively, and then concatenated. On the other hand, in the second mode (e.g., the full-bit mode), the 4-bit shifted MSB adder tree result and LSB adder tree result may be added and accumulated in the similar 24-bit SHIFT_ACCUM module.

In the second case, a slight (e.g., 3-bit) waste of resources occurs in the second mode (e.g., the full-bit mode) compared to the first case. However, the 24-bit accumulation buffer is used, while the 45-bit accumulation buffer is used in the first case overall. Accordingly, the accumulation buffer size may be reduced and it may be advantageous in a viewpoint of power/area.

Referring to FIG. 10, a memory device according to an example may arrange positions of an ACCUM_MUX module and a SHIFT_ACCUM module in two cases.

Referring to a diagram 1010, a first case is a case where an output from each adder tree is accumulated through the SHIFT_ACCUM module and the accumulated result value is assigned according to the bit mode of the set 1 data in the ACCUM_MUX module and transferred to a MANTISSA_NORM module.

Referring to a diagram 1020, a second case is a case where the output from each adder tree is first assigned according to the bit mode of the set 1 data in the ACCUM_MUX module and this is transferred to and accumulated in the SHIFT_ACCUM module.

The first case has an advantage that an addition module in the ACCUM_MUX module is used only once after completing the accumulation for a bit-serial input, compared to the second case. However, a 4-bit input of the set 1 data and an 8-bit serial input value may be covered at most in the set 2 data, and thus a 16-bit accumulation buffer may be used instead of a 12-bit accumulation buffer.

Accordingly, the bit-width of the accumulation buffer may be implemented for the amount of 32-bit, and thus a larger bit-width (e.g., approximately 33) of the accumulation buffer may be used, compared to the second case in which 24-bit is used.

Referring to FIG. 11, in the second case, when the operation mode is the first mode (e.g., the half-bit mode), the multiplexer module of the memory device according to an example may shift an output value from the MSB adder tree by P* bit and an output signal obtained by adding this and the LSB input may be transferred to the shift accumulator. Here, P* may be equal to Expression 2 below, for example.

log 2(S)+M/2+Y/2 Expression 2:

In the second mode (e.g., the full-bit mode), the multiplexer module of the memory device according to an example may shift an output value from the MSB adder tree by M/2 bit and an output signal obtained by adding this and the LSB input may be transferred to the shift accumulator.

In this case, the bit-width of the shift accumulator according to an example may be determined by Expression 3 below, for example.

2 log 2(S)+M+Y Expression 3:

In Expressions 2 and 3, as described above, S, M, and Y may refer to the number of pieces of mantissa data of the set 1 data, a bit number of the mantissa data of the set 1 data, and a bit number of the mantissa data of the set 2 data, respectively.

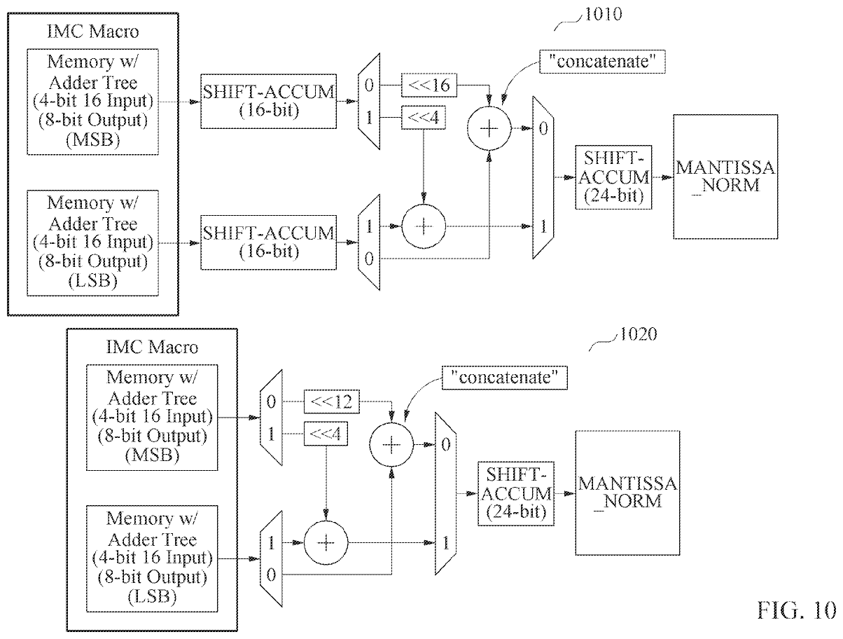

FIG. 12 illustrates an example of a method of operating an IMC macro.

Referring to FIG. 12, a memory device according to an example may write input set 1 data into a memory cell in a write mode. For example, when the number of pieces of the fraction data sharing one exponent is 16, the memory device may store one or more pieces of block floating point data composed of 16 pieces of 8-bit fraction data and one piece of 8-bit exponent data. Here, the exponent may be stored in the same memory as the fraction or may be stored in a separate register.

In a read mode, the memory device according to an example may perform an operation of reading the set 1 data stored in a memory cell according to a given address value and directly outputting this as an output value. The address value may include a bank value to be read, and thus may be implemented to read some or all of the banks.

In a zero write mode, the memory device according to an example may set a value of an all_zero register. When all of values written in a current memory cell are 0 or when it is desired to skip an operation without initializing the values of the current memory cell, an operation of setting the value of the all_zero register to 1 may be performed. When the value of the all_zero register is set to 1 in this way, a value of 0 may be output for all of arbitrary inputs when performing a streaming operation in a subsequent stream mode and an internal module may not be operated.

In the stream mode, the memory device according to an example may transfer a 16-bit STREAM_IN value input from outside to the IMC macro as an input of the streaming operation depending on the all_zero value, and determine whether to transfer 16 pieces of the set 1 data in one block stored in the memory cell to a next adder tree according to each bit value of STREAM_IN. Here, the memory device may also determine whether to transfer the value stored in the memory cell when the bit value of STREAM_IN is 1 by changing it to two's complement based on whether an operation currently being performed is a sign operation.

The memory device according to an example may stream the set 2 data in the bit-serial manner with respect to the set 1 data stored in the stream mode, and thus perform a vector-vector inner product operation or vector-matrix multiplication operation.

The streaming may be divided into two phases. When the exponent of the set 2 data includes X-bit and the fraction data includes Y-bit, S pieces of Y-bit fraction data of the set 2 data may be input to MSB and LSB in a bit-serial manner in first 1 to Y cycles as the data streaming, and this may be transferred to the IMC macro as a streaming input according to the all_zero register value. In the IMC macro, this is received and combined with internally stored set 1 data, an appropriate streaming output is transferred to the ACCUM_MUX module by performing the operation through a plurality of adder trees, and this may be accumulated in the SHIFT_ACCUM module.

An operation path from the IMC macro to the SHIFT_ACCUM module may be implemented as more than 1 cycle. Hereinafter, it is assumed in the example that the operation is performed fora total of 2 cycles through a buffer between the IMC macro and the ACCUM_MUX module. That is, an operation result for the streaming input received in a cycle 1 may be accumulated in the SHIFT_ACCUM module in a cycle 2.

The second phase may refer to a phase in which, from a Y+1 cycle, the exponent data of the set 2 data and the exponent data of the set 1 data may be added in the EXP_ADDER module, a value finally accumulated in the SHIFT_ACCUM module and an operation result of the EXP_ADDER module are normalized in the MANTISSA_NORM module to output one output result of two's complement floating point (TFP).

The second phase may be configured with one or more cycles. More specifically, the second phase may vary depending on how many cycles the operation from the IMC macro to the SHIFT_ACCUM module in the first phase may be configured with. For example, when the operation is configured with 2 cycles, the operation in the EXP_ADDER module and the SHIFT_ACCUM module may be completed and a normalized TFP value may be obtained in the Y+1 cycle. Also, according to the configuration, the memory device may output a value obtained through the MANTISSA_NORM module as a floating point in the sign-magnitude format.

When all pieces of data constituting the block floating point are 0, the memory device according to an example may include a separate masking register to record this case as 1, and when a corresponding register value is 1, the memory device may support a zero-skipping operation of skipping an operation for the corresponding block floating point.

Here, in a case of the masking register for the corresponding block floating point, a value thereof may be set to 1 separately even if all pieces of actual data are not 0. Accordingly, in a situation where data exists in an internal memory buffer, the zero-skipping operation may be performed or an initialization effect may be exhibited without initializing the buffer one by one.

FIG. 13 illustrates an example of an operation of a bit-serial counter.

Referring to FIG. 13, the bit-serial counter according to an example may control the operation of the computing module (e.g., the computing module 220 of FIG. 2).

The bit-serial counter according to an example may receive a preset stream_bit value and control operations of the EXP_ADDER module, ACCUM_MUX module, SHIFT_ACCUM module, and MANTISSA_NORM module. The stream bit value according to an example may be a fraction data bit value of the set 2 data.

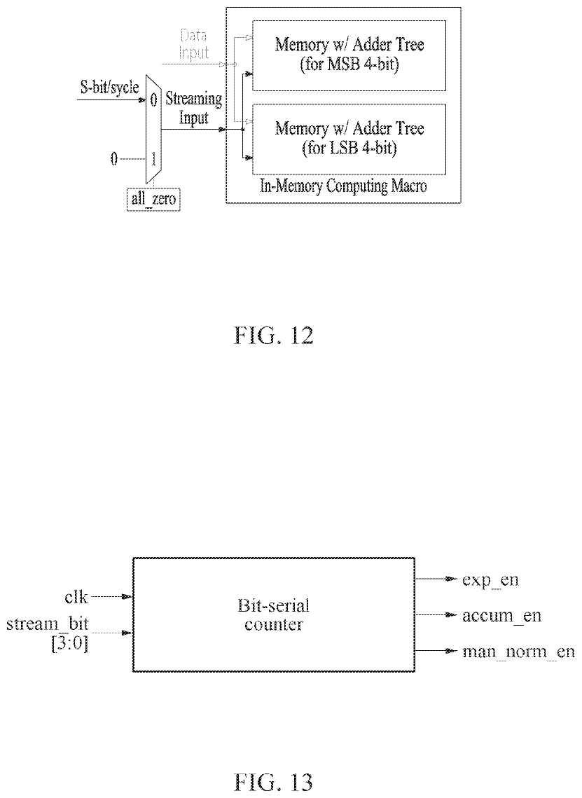

FIG. 14 illustrates an example of an operation of a multiplexer module.

Referring to FIG. 14, the ACCUM_MUX module according to an example may be a module for receiving an 8-bit output value (MSB_INPUT, LSB_INPUT) output from the adder tree of the IMC macro block as an input, and muxing this differently according to a bit mode (e.g., accum_mode) of the set 1 data to generate an input of the SHIFT_ACCUM module.

For example, when Accum_mode=1 which indicates a full-bit mode, the MSB input and the LSB input may be combined into one. Accordingly, the ACCUM_MUX module according to an example may shift the MSB input to the left by 4 bits and add two values.

On the other hand, when accum_mode=0 which indicates a half-bit mode, the MSB input and the LSB input are separate operation values for data. Accordingly, the ACCUM_MUX module according to an example may shift the MSB input to the left by 12 bits, add two values (that is, concatenate the MSB input and the LSB input), and output this value as an output.

The reason for the 12-bit left shift here is to avoid an effect on the MSB accumulated value and the LSB accumulated value when performing the accumulation in the SHIFT_ACCUM module, because a maximum accumulation result of each operation in the half-bit mode is 4-bit*4-bit*16=12-bit.

Furthermore, since the SHIFT_ACCUM module has a 24-bit accumulation buffer, the ACCUM_MUX module according to an example may generate the operation result as 24-bit accordingly and output it as an output.

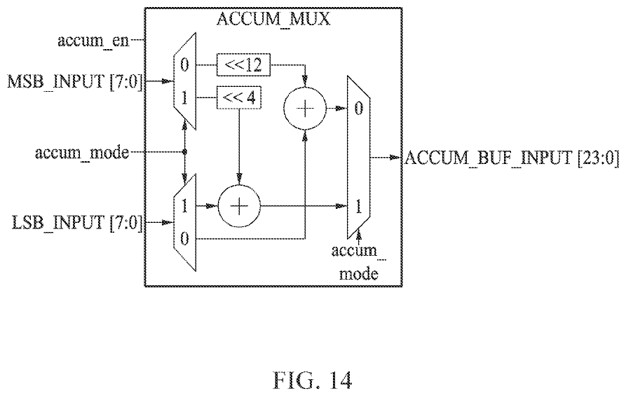

FIG. 15 illustrates an example of an operation of a shift accumulator.

Referring to FIG. 15, the SHIFT_ACCUM module according to an example may be a module for receiving an output value (ACCUM_BUF_INPUT[23:0]) of the ACCUM_MUX module as an input (DIN[23:0]), adding this and a value obtained by shifting a previous accumulation value of the accumulation buffer to the left by 1 bit by using the full adder, and accumulating this again in the accumulation buffer.

The SHIFT_ACCUM module according to an example may operate by receiving a control signal (e.g., accum_en) from a bit-serial counter, and determine whether to simply accumulate 24-bit inputs internally or accumulate each input by dividing by 12-bit according to the bit mode of the set 1 data. The SHIFT_ACCUM module according to an example may output it as an output when the accumulation is finished.

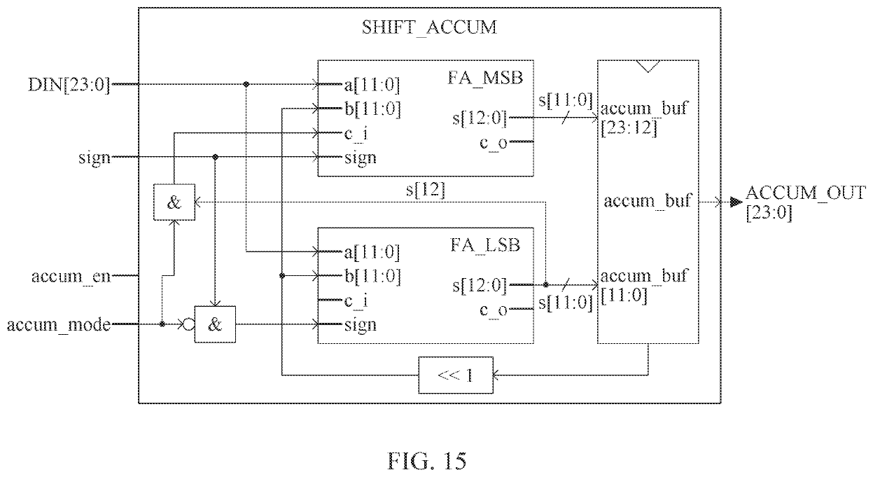

FIG. 16 illustrates an example of an operation of an exponent adder module.

Referring to FIG. 16, the exponent adder module according to an example may be a module for receiving and adding exponent data (e.g., IN_EXP[7:0]) of the set 1 data and exponent data (e.g., STREAM_EXP[7:0]) of the set 2 data.

Here, since each exponent data has a form in which a bias is added to the actual exponential value, an operation of subtracting the bias once may be used so that the bias is not added redundantly when adding two values.

The exponent adder module according to an example may perform an operation of performing addition and discarding an upper bit may be performed instead of an operation of subtracting the bias from the added value, to improve efficiency of the operation configuration.

For example, in a first operation mode (e.g., exp_mode=1 (full-bit mode)), a bias of 127 (8′b0111_1111) is added for each 8-bit exponent, and thus a value obtained by adding two values and subtracting 127 when performing the addition internally is to be obtained. In order to obtain such a value, the exponent adder module according to an example may add 129(8′b1000_0001) to a value obtained by adding two values and discard one upper bit, thereby obtaining the same value, and at the same time, may use only lower 8-bit excluding upper 1-bit among an 9-bit output as an output value, by adding 8′b1000_0001 having two 1, instead of performing the operation of subtracting 8′b0111_1111 having seven 1.

As another example, in a second operation mode (e.g., exp_mode=0 (half-bit mode)), a bias of 7 (4′b0111) is added for each 4-bit exponent, and thus a value obtained by adding two values and subtracting 7 when performing the addition internally is to be obtained. The exponent adder module according to an example may similarly add 9(4′1001) each and transfer lower 4-bit value obtained by extracting one upper bit among 5-bit result value as an output value.

In the second operation mode, the 8-bit IN_EXP and STREAM_EXP have different 4-bit exponent data in MSB 4-bit and LSB 4-bit, respectively, and the exponent adder module may perform the addition of MSB 4-bit and LSB 4-bit of the IN_EXP and STREAM_EXP, respectively, and output this again as MSB 4-bit and LSB 4-bit of the EXP_OUT.

Additionally, the exponent adder module may determine whether to consider the effect of the bias when performing the addition of IN_EXP and STREAM_EXP input internally through a control signal (e.g., bias_en). The reason why this signal exists is that the input of the memory device according to an example may be two's two's complement block floating point data, but it may also be a block fixed point or block integer value that shares a scale value. When receiving the block fixed point or block integer value, a separate bias may not be included in the scale value. Accordingly, in this case, the exponent adder module may set the control signal (e.g., bias_en) to 0 and may not consider the bias value when calculating the operation result.

The operation of the exponent adder module according to an example may be determined by a control signal (e.g., exp_en) of the bit-serial counter.

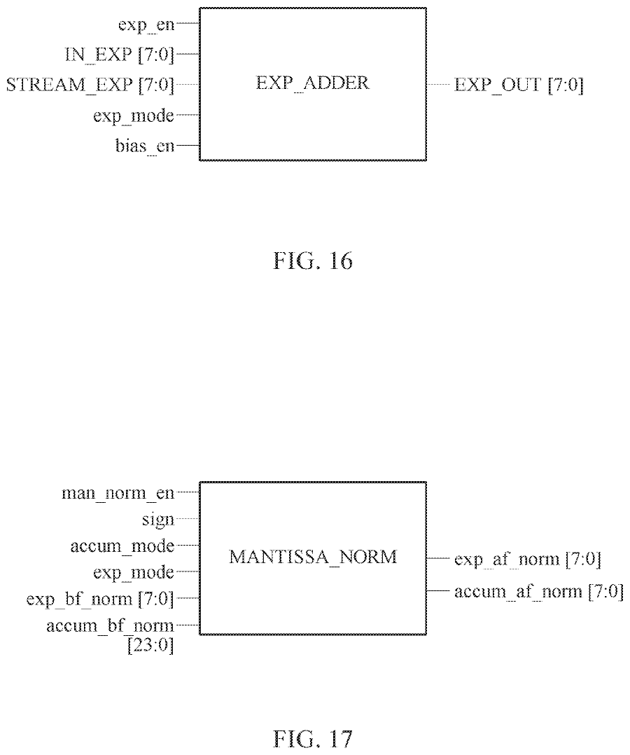

FIG. 17 illustrates an example of an operation of a normalization module.

Referring to FIG. 17, a normalization module according to an example may be a module for receiving a mantissa value (e.g., accum_bf_norm[23:0]) accumulated in the SHIFT_ACCUM module and an exponent value (e.g., exp_bf_norm[7:0]) accumulated in the exponent adder, normalizing each according to the operation mode (e.g., accum_mode and exp_mode), and finally outputting them as a 16-bit two's complement floating point (TFP) format (e.g., 8-bit exponent data and 8-bit fraction data). Here, the 8-bit fraction data may have a data format interpreted as 2-bit integer and 6-bit fraction.

The normalization module according to an example may shift input fraction data to a signed fraction with an integer of [−2 to 1] or an unsigned fraction with an integer of [0 to 3] according to an accum_mode signal and a sign signal and output a value in which the corresponding shift value is reflected to the exponent. The normalization module according to an example may perform appropriate exception processing when a value before the normalization exceeds a range that may be expressed in an actual 16-bit TFP.

The operation of the normalization module according to an example may be determined by a control signal (e.g., man_norm_en) of the bit-serial counter.

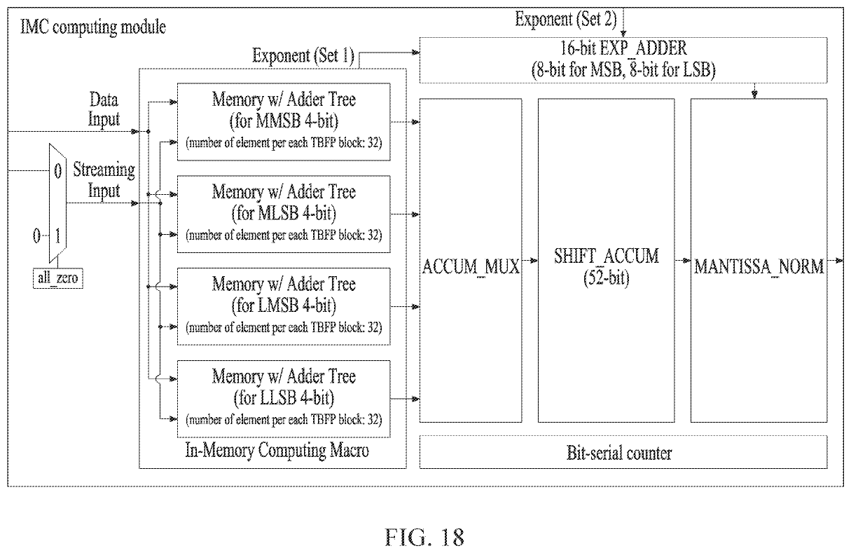

FIG. 18 illustrates an example of performing an operation by using a plurality of IMC macro blocks.

As the bit number of the set 1 data and the set 2 data according to an example varies, the size of the memory cell of the IMC macro, the number and input/output number of adder trees, the bit number of the bit-serial counter, a configuration of the ACCUM_MUX module, the bit number of the accumulation buffer of the SHIFT_ACCUM module, the input/output bit number of the EXP_ADDER module, a normalization range of the MANTISSA_NORM module, and the like may vary, and the input/output bit number of the memory device may also vary.

For example, referring to FIG. 18, four IMC macro blocks according to an example may perform a vector-vector inner product or vector-matrix multiplication operation with each 4-bit adder tree for two's complement block floating point (TBFP32) data in which 32 pieces of 16-bit signed fraction data share one 16-bit exponent.

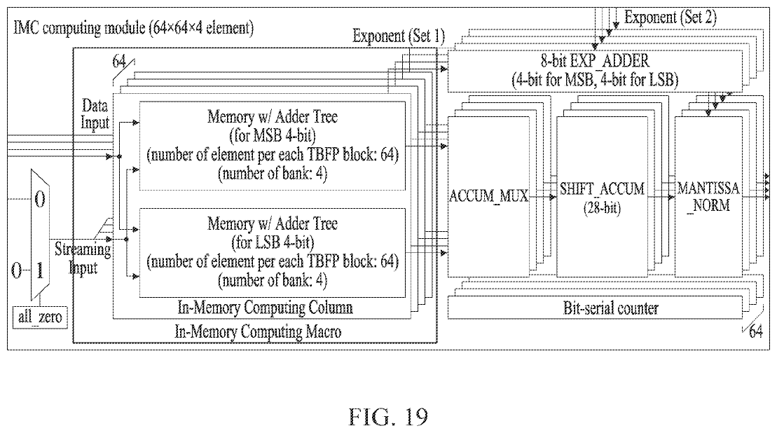

FIG. 19 illustrates an example of performing an operation by using a plurality of IMC columns.

Referring to FIG. 19, the memory device according to an example may include a plurality of IMC columns (e.g., 64 columns). A memory device according to an example may perform a vector-matrix multiplication operation for two's complement block floating point (TBFP16) data in which 64 pieces of 8-bit signed fraction data share one 8-bit exponent, the operation of storing a total of 64 pieces of TBFP16 set 1 data in the IMC macro, streaming one TBFP16 set 2 data as an input in a bit-serial manner, inputting this to the 64 IMC columns in parallel at the same time, and outputting a total of 64 FP16 output values.

For example, the memory device may perform an operation of multiplying a (1×64) input of which each element is FP16 by a (64×64) weight.

Further, in the memory device according to an example, an internal memory cell is composed of four banks. Accordingly, a total of four pieces of (64×64) set 1 data (e.g., the weight) may be stored, and thus an operation for four pieces of different (64×64) set 1 data may be performed for one input with a time difference.

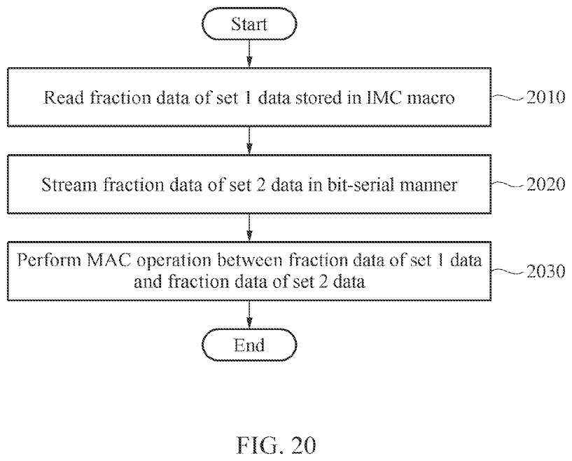

FIG. 20 illustrates an example of a method of operating a memory device.

For convenience of description, operations 2010 to 2030 are described as being performed by the memory device 200 shown in FIG. 2. However, operations 2010 to 2030 may be performed by another suitable electronic device in a suitable system.

Furthermore, the operations 2010 to 2030 of FIG. 20 may be performed in the shown order and manner. However, one or more of the operations 2010 to 2030 may be changed or omitted without departing from the spirit and scope of the shown example. For example, one or more of the operations shown in FIG. 20 may be performed in parallel or simultaneously. In addition to the description of FIG. 20 below, the descriptions of FIGS. 1 through 19 are also applicable to FIG. 20 and are incorporated herein by reference.

In operation 2010, the memory device 200 according to an example may read the fraction data of the set 1 data stored in the IMC macro.

In operation 2020, the memory device 200 according to an example may stream the fraction data of the set 2 data in a bit-serial manner.

A plurality of pieces of data included in the set 1 data according to an example may share a first exponent, and a plurality of pieces of data included in the set 2 data may be block floating point data sharing a second exponent.

Furthermore, the fraction data of the set 1 data may be converted into two's complement format and stored in the IMC macro, and the fraction data of the set 2 data may be converted into two's complement format and streamed.

In operation 2030, the memory device 200 according to an example may perform the MAC operation between the fraction data of the set 1 data and the fraction data of the set 2 data.

Furthermore, the IMC macro according to an example may include a plurality of IMC macro blocks, and the memory device 200 may transfer an output signal corresponding to each of the plurality of operation modes to the shift accumulator by using a multiplexer module connected to at least one IMC macro block among the plurality of IMC macro blocks, and accumulate an adder tree operation result based on the output signal corresponding to each of the plurality of operation modes by using the shift accumulator. At this time, the plurality of operation modes may be determined based on the plurality of IMC macro blocks.

The memory device 200 according to an example may perform the addition operation between the exponent data of the set 1 data and the exponent data of the set 2 data, and may output an operation result between the set 1 data and the set 2 data based on the MAC operation result and a result of performing the addition operation.

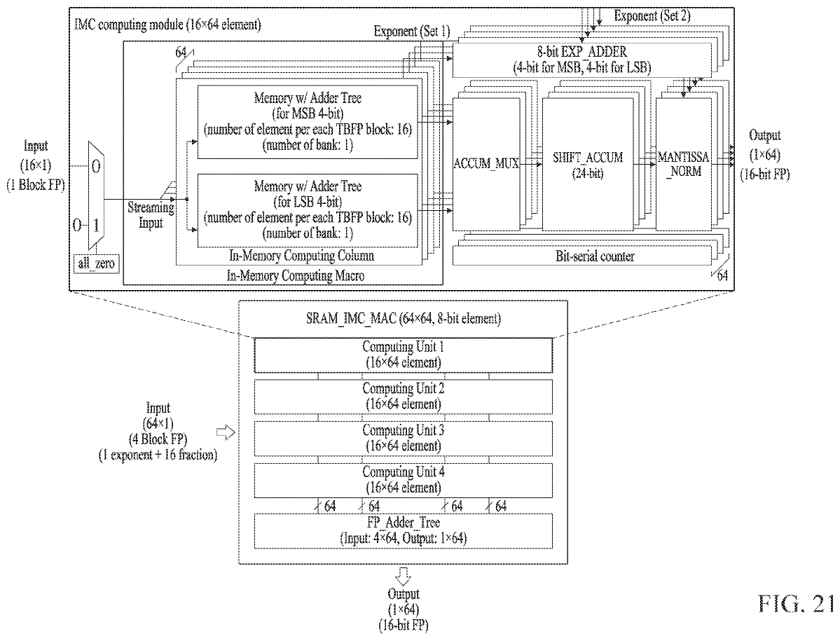

FIG. 21 illustrates an example of replacing an IMC macro with an SRAM-based IMC IP according to an example.

An SRAM IMC may include a single-bit word-line and a single-bit cell, and may perform the MAC operation by receiving a single bit in each row. Accordingly, if the corresponding SRAM IMC may store the fraction data of the set 1 data in the plurality of bit cells, drive this to the bit-serial fraction data of the set 2 data, and perform the IMC operation of performing the addition by the adder tree, the memory buffer and the adder tree according to an example may be replaced with the corresponding SRAM IMC.

In the memory device according to an example, a group (e.g., 16 pieces) of the block floating points sharing the same exponent is set as one unit. Accordingly, if the number (e.g., 64) of stored data of the actual SRAM IMC is larger than the size of the block floating point, a plurality of memory devices is grouped and a method of adding each result using the adder tree to obtain a final output may be used.

FIG. 21 illustrates an example in which the IMC macro capable of storing 4-bit element by (16×64) is replaced with the SRAM IMC IP, four memory devices are disposed, and an output value is added through a FP adder tree, and thus a (64×1) vector input of which each element represents FP16 and a (64×64) matrix weight are multiplied to obtain an (1×64) vector output, but there is no limitation thereto. The memory device according to an example may output not only a floating point but also a block floating point. For example, the memory device according to an example may output a block FP vector having A (e.g., 4) (1*B) (e.g., (1*16)) size. The output vector format according to an example may be adjusted in the MANTISSA_NORM module, but is not limited thereto.

However, in the example, one bank is used for convenience, but, in practice, it is common to set several banks to share the same digital operation portion for efficient hardware configuration, and thus the plurality of banks may be configured.

The processors, memory devices, IMC macros, computing modules, memories, IMC computing modules, IMC macro blocks, first IMC macro blocks, second IMC macro blocks, multiplexer modules, shift accumulator modules, normalization modules, exponent adder modules, bit-serial counter modules, processor 120, memory device 110, memory device 200, IMC macro 210, computing module 220, memory 211, IMC computing module 213, memory device 700, IMC macro 710, IMC macro block 711, first IMC macro block 711, second IMC macro block 712, computing module 720, multiplexer module 721, shift accumulator module 722, normalization module 723, exponent adder module 724, bit-serial counter module 725, memory device 800, and other apparatuses, devices, and components described and disclosed herein with respect to FIGS. 1-21 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-21 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A memory device comprising:
a computing module; and
an in-memory computing (IMC) macro comprising:
a memory comprising a plurality of bit cells storing pieces of fraction data of a first data set; and
an IMC computing module configured to perform an operation between the pieces of fraction data of the first data set read from the memory and pieces of fraction data of a second data set received from an input control module,
wherein a plurality of pieces of data included in the first data set share a first exponent, and
wherein a plurality of pieces of data included in the second data set share a second exponent.

2. The memory device of claim 1,
wherein the pieces of the fraction data of the first data set are converted into the format of two's complement and stored in the plurality of bit cells, and
wherein the pieces of the fraction data of the second data set are converted into the format of two's complement and streamed in the IMC macro.

3. The memory device of claim 2,
wherein the IMC computing module comprises:
a multiplier configured to perform a multiplication operation between the pieces of the fraction data of the first data set and the pieces of the fraction data of the second data set; and
an adder tree configured to add results of performing the multiplication operation, and
wherein the adder tree is configured with a full adder.

4. The memory device of claim 1, wherein the IMC computing module is configured to stream the pieces of the fraction data of the second data set in a bit-serial manner.

5. The memory device of claim 1,
wherein the IMC macro comprises a plurality of IMC macro blocks, and
wherein the computing module further comprises a shift accumulator configured to accumulate adder tree operation results of each of the plurality of IMC macro blocks.

6. The memory device of claim 5,
wherein the computing module further comprises a multiplexer module configured to be connected to one or more IMC macro blocks among the plurality of IMC macro blocks and transmit an output signal corresponding to each of a plurality of operation modes to the shift accumulator, and
wherein the shift accumulator is configured to be connected to the multiplexer module and accumulate the adder tree operation results based on the output signal corresponding to each of the plurality of operation modes.

7. The memory device of claim 6, wherein the plurality of operation modes is determined based on the plurality of IMC macro blocks.

8. The memory device of claim 1, wherein the computing module further comprises:
an exponent adder configured to perform an addition operation between exponent data of the first data set and exponent data of the second data set.

9. The memory device of claim 1, wherein the computing module further comprises:
a normalization module configured to receive an output of a shift accumulator and an output of an exponent adder and output a result of an operation between the first data set and the second data set.

10. The memory device of claim 1, wherein the computing module further comprises:
a bit-serial counter configured to control operations of a multiplexer module, shift accumulator, exponent adder, and normalization module based on the fraction data of the second data set.

11. The memory device of claim 1,
wherein the IMC macro comprises a first IMC macro block and a second IMC macro block, and
wherein the computing module further comprises a multiplexer module configured to:
perform a concatenate operation on an adder tree operation result of the first IMC macro block and an adder tree operation result of the second IMC macro block in response to a first operation mode; and
perform an addition operation between a value obtained by shifting the adder tree operation result of the first IMC macro block by a first bit and the adder tree operation result of the second IMC macro block in response to a second operation mode.

12. The memory device of claim 11, wherein the computing module further comprises a shift accumulator configured to:
accumulate results of performing the concatenate operation by dividing the results into two in response to the first operation mode; and
accumulate results of performing the addition operation in response to the second operation mode.

13. The memory device of claim 12, wherein a bit-width of the shift accumulator is determined based on the number of the pieces of the fraction data of the first data set, a bit number of the pieces of the fraction data of the first data set, and a bit number of the pieces of the fraction data of the second data set.

14. A processor-implemented method of operating a memory device, the method comprising:
reading pieces of fraction data of first data set stored in an in-memory computing (IMC) macro;
streaming fraction data of second data set in a bit-serial manner; and
performing a multiply and accumulate (MAC) operation between the fraction data of the first data set and the fraction data of the set 2 data,
wherein a plurality of pieces of data included in the first data set shares a first exponent, and
wherein a plurality of pieces of data included in the second data set shares a second exponent.

15. The method of claim 14,
wherein the pieces of the fraction data of the first data set are converted into the format of two's complement and stored in the IMC macro, and
wherein the pieces of the fraction data of the second data set are converted into the format of two's complement and streamed in the IMC macro.

16. The method of claim 14,
wherein the IMC macro comprises a plurality of IMC macro blocks, and
wherein the method further comprises:
transmitting an output signal corresponding to each of a plurality of operation modes to a shift accumulator by using a multiplexer module connected to one or more IMC macro blocks among the plurality of IMC macro blocks; and
accumulating adder tree operation results of each of the plurality of IMC macro blocks based on the output signal corresponding to each of the plurality of operation modes by using the shift accumulator.

17. The method of claim 16, wherein the plurality of operation modes is determined based on the plurality of IMC macro blocks.

18. The method of claim 14, further comprising:
performing an addition operation between exponent data of the first data set and exponent data of the second data set; and
outputting a result of an operation between the first data set and the second data set based on a result of the MAC operation and a result of performing the addition operation.

19. A non-transitory computer-readable storage medium storing instructions that, when executed by a processor, configure the processor to perform the method of claim 14.

20. A memory device comprising:
an in-memory computing (IMC) macro comprising:
a memory comprising a plurality of bit cells storing pieces of fraction data of a first data set; and
an IMC computing module configured to perform an operation between the pieces of fraction data of the first data set read from the memory and pieces of fraction data of a second data set received from an input control module,
wherein a plurality of pieces of data included in the first data set share a first exponent, and
wherein a plurality of pieces of data included in the second data set share a second exponent.
